(19) United States
(12) Patent Application Publication
(10) Pub. No.: US 2026/0302296 A1
(43) Pub. Date: Oct. 1, 2026

(54) Apparatus for Controlling Valve of Fuel Cell System, Method Thereof and Vehicle Including Same

(71) Applicants: Hyundai Motor Company, Seoul (KR); Kia Corporation, Seoul (KR)

(72) Inventors: Min Gu Park, Hwaseong-Si (KR); Jae Sung Ryu, Hwaseong-Si (KR); Ji Hoon Ryu, Hwaseong-Si (KR)

(21) Appl. No.: 19/298,759

(22) Filed: Aug. 13, 2025

(30) Foreign Application Priority Data
Mar. 25, 2025 (KR) 10-2025-0038199

(51) Int. Cl. H01M 8/04746; B60L 50/72; B60L 58/30; H01M 8/04082; H01M 8/04228; H01M 8/04303; H01M 8/0438

(52) U.S. Cl. CPC H01M 8/04783; B60L 50/72; B60L 58/30; H01M 8/04201; H01M 8/04228; H01M 8/04303; H01M 8/0438; H01M 8/04432; H01M 8/04753; H01M 2250/20

(57) ABSTRACT

Disclosed are an apparatus for controlling a valve of a fuel cell system, and a method thereof. The apparatus includes a valve configured to discharge, through an exhaust of the fuel cell system, gas inside a cathode of a fuel cell stack of the fuel cell system. The apparatus may, for example, determine, based on a pressure measured inside the fuel cell stack, an opening time of the valve and an opening time duration of the valve, and open, while the fuel cell system is in a shutdown state, the valve at the opening time and keep the valve open for the opening time duration.

### CROSS-REFERENCE TO RELATED APPLICATION

This application claims the benefit of and priority to Korean Patent Application No. 10-2025-0038199, filed in the Korean Intellectual Property Office on Mar. 25, 2025, the entire contents of which are incorporated herein by reference.

### TECHNICAL FIELD

The present disclosure relates to fuel cell systems, and more particularly to a technology for controlling an air cut-off valve (ACV).

### BACKGROUND

A fuel cell is a type of power generator that converts the chemical energy of fuel into electrical energy through an electrochemical reaction within a stack rather than converting it into heat through combustion. The fuel cell may be used not only to supply for power industrial, household, and transportation needs, but also to supply power to small electric and electronic products, especially portable devices.

Currently, a polymer electrolyte membrane (PEM) fuel cell, such as a proton-exchange membrane fuel cell (PEMFC), which has one of the highest power densities among fuel cells, has been studied widely as a power source for driving a vehicle. A PEM fuel cell typically has a fast start-up time and fast power conversion response time due to its low operating temperature.

The matters described in this background section are intended to promote an understanding of the background of the disclosure and may include matters that are not already known to those of ordinary skill in the art.

### SUMMARY

The present disclosure has been made to solve the above-mentioned problems occurring in at least some implementations while advantages achieved by those implementations are maintained intact.

One aspect of the present disclosure provides apparatus for controlling a valve of a fuel cell system, a method thereof, and a vehicle including the same, which are capable of determining an opening time and an opening time duration (also referred to as an opening maintenance time) of an air cut-off valve (ACV) and opening the ACV at the opening time and during the opening time duration to control the cathode pressure of a stack to below atmospheric pressure when the fuel cell system is in a shutdown state, such that the closed state of the ACV is maintained even when the closing torque applied to the ACV is stopped.

Another aspect of the present disclosure provides apparatus for controlling a valve of a fuel cell system, a method thereof, and a vehicle including the same, which are capable of obtaining an anode pressure, a first cathode pressure and an atmospheric pressure before a shutdown of the fuel cell system, predicting a second cathode pressure after the shutdown based on the anode pressure and the first cathode pressure, determining the opening time of an ACV based on the second cathode pressure and the atmospheric pressure, opening the ACV at the opening time, predicting a trend (e.g., determining a projected trend) of the second cathode pressure according to the opening of the ACV, and determining an opening time duration of the ACV based on the trend of the second cathode pressure to control the cathode pressure of a stack to below the atmospheric pressure, such that the closed state of the ACV is maintained even when the closing torque applied to the ACV is stopped.

Still another aspect of the present disclosure provides apparatus for controlling a valve of a fuel cell system, a method thereof, and a vehicle including the same, which are capable of obtaining an anode pressure, a first cathode pressure and an atmospheric pressure before a shutdown of the fuel cell system, predicting a second cathode pressure after the shutdown based on the anode pressure and the first cathode pressure, determining, as the opening time of an ACV, a time when a difference between the second cathode pressure and the atmospheric pressure is less than a reference pressure (e.g., a threshold value) corresponding to a reference emission (concentration) value (e.g., a maximum (legally) allowed emission concentration amount (e.g., 8%)) for hydrogen, opening the ACV at the opening time, predicting a trend line of the second cathode pressure according to the opening of the ACV, determining an opening end time (also referred to as a closing time) at which a value obtained by integrating the trend line of the second cathode pressure from the opening time of the ACV is less than a reference integral value corresponding to a reference average emission concentration value (e.g., average 4% for 3 seconds) for hydrogen, and determining a time from the opening time to the opening end time as the opening time duration of the ACV to control the cathode pressure of a stack to below the atmospheric pressure, such that the closed state of the ACV is maintained even when the closing torque applied to the ACV is stopped. For example, the closing time may be a time at which an integral, from the opening time, of an area below the projected trend line of the estimated cathode pressure is less than a reference integral value.

The technical problems to be solved by the present disclosure are not limited to the aforementioned problems, and any other technical problems not mentioned herein will be clearly understood from the following description by those skilled in the art to which the present disclosure pertains. Also, it may be easily understood that the objects and advantages of the present disclosure may be realized by the units and combinations thereof recited in the claims.

According to one or more example embodiments of the present disclosure, an apparatus of a fuel cell system may include: a valve configured to discharge, through an exhaust of the fuel cell system, gas inside a cathode of a fuel cell stack of the fuel cell system; a processor; and a memory. The memory may store at least one instruction that is configured, when executed by the processor communicating with the memory, to cause the apparatus to: determine, based on a pressure measured inside the fuel cell stack, an opening time of the valve and an opening time duration of the valve; and open, while the fuel cell system is in a shutdown state, the valve at the opening time and keep the valve open for the opening time duration.

The at least one instruction may be configured, when executed by the processor communicating with the memory, to cause the apparatus to determine the opening time by: obtaining, before a shutdown of the fuel cell system, an anode pressure, a cathode pressure, and an atmospheric pressure; determining, based on the anode pressure and the cathode pressure, an estimated cathode pressure after the shutdown of the fuel cell system; and determining, based on the estimated cathode pressure and based on the atmospheric pressure, the opening time of the valve.

The at least one instruction may be configured, when executed by the processor communicating with the memory, to cause the apparatus to determine the opening time by: obtaining, before a shutdown of the fuel cell system, an anode pressure, a cathode pressure, and an atmospheric pressure; and determining, based on the anode pressure and the cathode pressure, an estimated cathode pressure after the shutdown of the fuel cell system. The opening time of the valve may be associated with a time when a difference between the estimated cathode pressure and the atmospheric pressure is less than a reference pressure.

The at least one instruction may be configured, when executed by the processor communicating with the memory, to further cause the apparatus to determine the reference pressure based on a reference emission concentration value for hydrogen.

The at least one instruction may be configured, when executed by the processor communicating with the memory, to cause the apparatus to determine the opening time duration by: determining a projected trend of the estimated cathode pressure after the valve opens; and determining the opening time duration of the valve based on the projected trend of the estimated cathode pressure.

The at least one instruction may be configured, when executed by the processor communicating with the memory, to cause the apparatus to determine the opening time duration by: determining a projected trend line of the estimated cathode pressure after the valve opens; determining a closing time of the valve by determining a time at which an integral, from the opening time, of an area below the projected trend line of the estimated cathode pressure is less than a reference integral value; and determining the opening time duration based on a time duration between the opening time and the closing time.

The at least one instruction may be configured, when executed by the processor communicating with the memory, to further cause the apparatus to determine the reference integral value based on a reference average emission concentration value for hydrogen.

The at least one instruction may be configured, when executed by the processor communicating with the memory, to further cause the apparatus to determine the estimated cathode pressure by: determining the estimated cathode pressure using curve fitting.

According to one or more example embodiments of the present disclosure, a method performed by a fuel cell system may include: determining, by a processor of the fuel cell system and based on a pressure measured inside a fuel cell stack of the fuel cell system, an opening time and an opening time duration of a valve of the fuel cell system; and opening, while the fuel cell system is in a shutdown state, the valve at the opening time to discharge gas inside a cathode of the fuel cell stack and keeping the valve open for the opening time duration.

Determining the opening time of the valve may include: obtaining, before a shutdown of the fuel cell system, an anode pressure, a cathode pressure, and an atmospheric pressure; determining, based on the anode pressure and the cathode pressure, an estimated cathode pressure after the shutdown of the fuel cell system; and determining, based on the estimated cathode pressure and based on the atmospheric pressure, the opening time of the valve.

Determining the opening time of the valve may include: obtaining, before a shutdown of the fuel cell system, an anode pressure, a cathode pressure, and an atmospheric pressure; and determining, based on the anode pressure and the cathode pressure, an estimated cathode pressure after the shutdown of the fuel cell system. The opening time of the valve may be associated with a time when a difference between the estimated cathode pressure and the atmospheric pressure is less than a reference pressure.

The method may further include determining the reference pressure based on a reference emission concentration value for hydrogen.

Determining the opening time duration of the valve may include: determining a projected trend of the estimated cathode pressure after the valve opens; and determining the opening time duration of the valve based on the projected trend of the estimated cathode pressure.

Determining the opening time duration of the valve may include: determining a projected trend line of the estimated cathode pressure after the valve opens; determining a closing time of the valve by determining a time at which an integral, from the opening time, of an area below the projected trend line of the estimated cathode pressure is less than a reference integral value; and determining the opening time duration based on a time duration between the opening time and the closing time.

The method may further include determining the reference integral value based on a reference average emission concentration value for hydrogen.

Determining the estimated cathode pressure may include: determining the estimated cathode pressure using curve fitting.

According to one or more example embodiments of the present disclosure, a vehicle may include a fuel cell stack configured to produce electrical energy. The fuel cell stack may include a cathode and an exhaust. The vehicle may further include an air compressor configured to supply air to the cathode of the fuel cell stack; a valve configured to discharge, through the exhaust, gas inside the cathode; and a processor circuit. The processor circuit may be configured to: determine, based on a pressure measured inside the fuel cell stack, an opening time of the valve and an opening time duration of the valve; and open, while the fuel cell system is in a shutdown state, the valve at the opening time and keep the valve open for the opening time duration.

The processor circuit may be configured to determine the opening time by: obtaining, before a shutdown of the fuel cell stack, an anode pressure, a cathode pressure, and an atmospheric pressure; determining, based on the anode pressure and the cathode pressure, an estimated cathode pressure after the shutdown of the fuel cell stack; and determining, based on the estimated cathode pressure and based on the atmospheric pressure, the opening time of the valve.

The processor circuit may be configured to determine the opening time duration by: determining a projected trend of the estimated cathode pressure after the valve opens; and determining the opening time duration of the valve based on the projected trend of the estimated cathode pressure.

The processor circuit may be configured to determine the opening time duration by: determining a projected trend line of the estimated cathode pressure after the valve opens; determining a closing time of the valve by determining a time at which an integral, from the opening time, of an area below the projected trend line of the estimated cathode pressure is less than a reference integral value; and determining the opening time duration based on a time duration between the opening time and the closing time.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram illustrating an example fuel cell system;

FIG. 2 is a block diagram illustrating an apparatus for controlling a valve of an example fuel cell system;

FIG. 3 is a diagram illustrating a process in which a controller provided in an apparatus for controlling a valve of an example fuel cell system determines the opening time and the opening maintenance time of an ACV;

FIG. 4 is a flowchart illustrating an example method of controlling a valve of a fuel cell system; and

FIG. 5 is a block diagram illustrating an example computing system for executing a method of controlling a valve of a fuel cell system.

### DETAILED DESCRIPTION

Hereinafter, one or more example embodiments of the present disclosure will be described in detail with reference to the exemplary drawings. In adding the reference numerals to the components of each drawing, it should be noted that the identical or equivalent component is specified by the identical numeral even when they are displayed on other drawings. Further, in describing the example embodiment(s) of the present disclosure, a detailed description of the related known configuration or function may be omitted when it is determined that it interferes with the understanding of the example embodiment(s) of the present disclosure.

Terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The term “unit” as used herein may refer to software, or hardware component such as Field-Programmable Gate Array (FPGA), Application Specific Integrated Circuit (ASIC), etc. However, “unit” is not limited to hardware and software. The “unit” may be configured to be stored in an addressable storage medium, or may be configured to execute one or more processors. The “unit” may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

A polymer electrolyte membrane (PEM) fuel cell may include a membrane electrode assembly (MEA). The MEA may consist of catalyst electrode layers, at which an electrochemical reaction may occur, and a solid polymer electrolyte membrane, which is permeable by hydrogen ions. Each of the catalyst electrode layers may be attached on either side of the solid polymer electrolyte membrane. The PEM fuel cell may also include a gas diffusion layer (GDL) for evenly distributing reaction gases and transmitting the generated electric energy, a gasket and a fastening device for maintaining the tightness and proper fastening pressure of reaction gases and cooling water, and a bipolar plate for moving reaction the gases and cooling water.

When assembling a fuel cell stack using one or more such unit cells, the combination of the membrane electrode assembly and the gas diffusion layer, which may be considered the main components, may be located at the innermost part of the cell. The MEA may include catalyst electrode layers (e.g., an anode and a cathode), which are catalysts that are applied on both sides of a polymer electrolyte membrane such that hydrogen reacts with oxygen. A gas diffusion layer, a gasket, and the like of the MEA are stacked between the anode and cathode. Thus, the polymer electrolyte membrane is sandwiched between the catalyst electrode layers, and the membrane and the catalyst electrode layers are further sandwiched between the gas diffusion layer, the gasket, etc. A separator may be positioned outside the gas diffusion layer. In the separator, a flow field may be formed. Reaction gas (hydrogen as fuel and oxygen or air as oxidizer) may be supplied and cooling water may pass through the flow field.

Using such a configuration in a unit cell, a plurality of unit cells may be stacked, and then a current collector, an insulating plate, and an end plate for supporting the stacked cells may be combined on the outermost side. By repeatedly stacking and connecting the unit cells between end plates, a fuel cell stack may be formed.

In order to obtain the required potential in an automotive vehicle, a suitable quantity of unit cells may be stacked to meet the required potential. The stacked unit cells may be referred to as a stack. The potential generated from one unit cell may be approximately 1.3 V. A plurality of cells may be stacked in series to produce the power required to operate a vehicle.

If hydrogen is supplied to the fuel electrode of such a stack and oxygen is supplied to the air electrode, hydrogen ions may be separated through a catalytic reaction at the fuel electrode. The separated hydrogen ions may be transferred to the oxidizing electrode, which is the air electrode, through an electrolyte membrane, and at the oxidizing electrode, the hydrogen ions separated from the fuel electrode, along with electrons and oxygen, may cause an electrochemical reaction, such that electrical energy is obtained. Specifically, electrochemical oxidation of hydrogen may occur at the fuel electrode, and electrochemical reduction of oxygen may occur at the air electrode. Electricity and heat may be generated by the exchange of electrons generated during this process, and water vapor or liquid water may be generated by the chemical reaction of combining hydrogen and oxygen.

A fuel cell system may close an air cut-off valve (ACV) and fill the anode of stack with hydrogen to prevent deterioration of the stack during and/or after a shutdown process. However, as hydrogen is supplied to the anode of the stack, the pressure of the cathode of the stack may increase due to a crossover phenomenon.

At least in some implementations of controlling an ACV in a fuel cell system, the system may close the ACV by applying torque to the ACV only for a predetermined amount of time (e.g., for 1 hour), with an assumption that power may not always be available and continuously supplied from a low-voltage battery installed in a vehicle. However, because the pressure on the cathode side remains higher than the atmospheric pressure even after the predetermined amount of time elapses, the ACV may be opened by the pressure on the cathode side, and it may be difficult to maintain the airtight state (e.g., seal) of the cathode. The various example method(s) and apparatus(es) described in the present disclosure can provide a superior performance of the fuel cell system by, for example, improving the mechanism associated with the ACV.

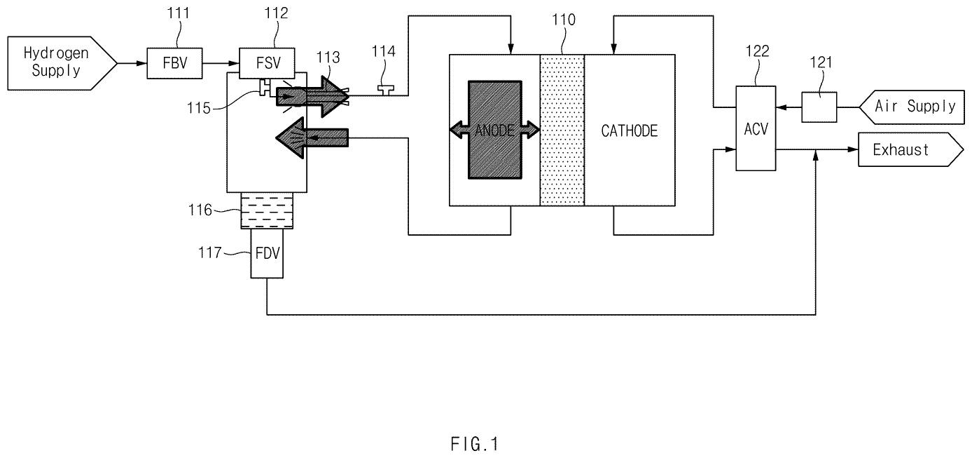

FIG. 1 is a diagram illustrating an example fuel cell system.

As illustrated in FIG. 1, a fuel cell system may include a fuel cell stack 110, a fuel block valve (FBV) 111, a fuel supply valve (FSV) 112, a fuel ejector (FEJ) 113, a fuel pressure sensor (FPS) 114, a fuel supply pressure sensor (FSPS) 115, a fuel-line water trap (FWT) 116, a fuel discharge valve (FDV) 117, an air compressor 121, an air flow control valve (ACV) 122, and the like.

Regarding each component, first, the FBV 111 may perform a function of blocking hydrogen supplied to the fuel cell stack 110. The FSV 112 may perform a function of controlling the pressure of hydrogen supplied to the fuel cell stack 110. The FEJ 113 may perform a function of applying pressure to hydrogen to supply the hydrogen to the fuel cell stack 110. The FPS 114 may perform a function of measuring the pressure of hydrogen supplied to the fuel cell stack 110. The FSPS 115 may perform a function of measuring the initial pressure of hydrogen supplied to the fuel cell stack 110. The FWT 116 may perform a function of storing water. The FDV 117 may perform a function of discharging condensed water and impurities at an anode side in the fuel cell stack 110. The fuel cell stack 110 produces electrical energy.

The air compressor 121 may supply air to the cathode of the fuel cell stack 110. In this case, the driving level (e.g., lowest, middle, highest, or the like) of the air compressor 121 may be determined by a fuel cell control unit (FCU).

The ACV 122, which is a valve that opens and closes under the control of the FCU, may connect or block an air supply line and an air discharge line.

The ACV 122 may discharge all of the air supplied from the air compressor 121 through the air discharge line (also referred to as an exhaust) without supplying the air to the cathode of the fuel cell stack 110.

In addition, the ACV 122 may supply part of the air supplied from the air compressor 121 to the cathode of the fuel cell stack 110 and discharge the remaining air through the air discharge line. At the same time, the ACV 122 may also discharge air that passes through the cathode of the fuel cell stack 110 through the air discharge line. That is, the ACV 122 may simultaneously discharge the remaining air and the air that passes through the cathode of the fuel cell stack 110 through the air discharge line.

In addition, the ACV 122 may supply air supplied from the air compressor 121 to the cathode of the fuel cell stack 110 and discharge air that has passes through the cathode of the fuel cell stack 110 through the air discharge line.

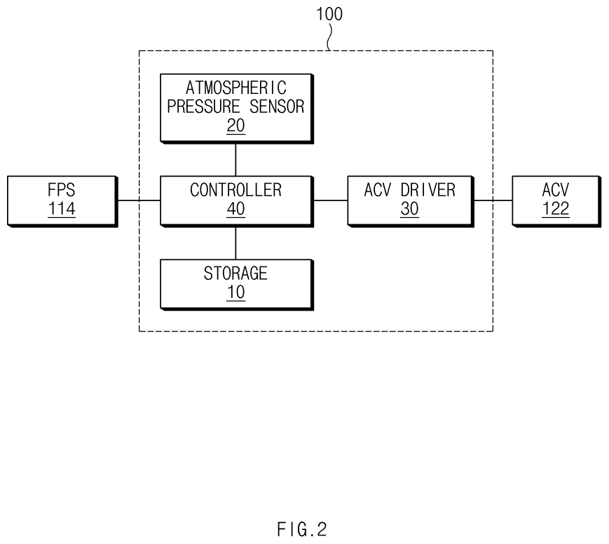

FIG. 2 is a block diagram illustrating an apparatus for controlling a valve of an example fuel cell system.

As illustrated in FIG. 2, an apparatus 100 for controlling a valve of a fuel cell system may include storage 10, an atmospheric pressure sensor 20, an air cut-off valve (ACV) driver 30, and a controller (also referred to as valve control device or valve control circuit) 40. In this case, depending on a scheme of implementing the apparatus 100 for controlling a valve of a fuel cell system, components may be combined with each other to be implemented as one, or some components may be omitted.

Regarding each component, first, the storage 10 may store various logic, algorithms and programs required in the process of determining an opening time (e.g., opening time point) and an opening maintenance time of the ACV 122, and, if the fuel cell system is in a shutdown state, opening the ACV 122 at the opening time and keeping the ACV 122 open during the opening maintenance time. The shutdown state of the fuel cell system may be a state in which the fuel cell system is not actively generating energy through chemical reactions. For example, in the shutdown state (e.g., after a shutdown), the fuel cell system may no longer provide any power or energy (or provide only a very small amount of power or energy under a threshold level) to a load, such as a powertrain (e.g., a motor) of a vehicle. Thus, in the shutdown state, the fuel cell system may not be in operation.

The storage 10 may store various logic, algorithms and programs required in the process of obtaining an anode pressure (e.g., a pressure of the hydrogen gas supplied to the anode compartment), a first cathode pressure (e.g., pressure of the oxidant gas (e.g., air, oxygen, etc.) supplied to the cathode compartment) and an atmospheric pressure before a shutdown of the fuel cell system, predicting a second cathode pressure (e.g., an estimated cathode pressure) after the shutdown based on the anode pressure and the first cathode pressure, determining the opening time of the ACV 122 based on the second cathode pressure and the atmospheric pressure, opening the ACV 122 at the opening time, predicting a trend of the second cathode pressure according to the opening of the ACV 122, and determining an opening maintenance time of the ACV 122 based on the trend of the second cathode pressure.

The storage 10 may store various logic, algorithms and programs required in the process of obtaining an anode pressure, a first cathode pressure and an atmospheric pressure before a shutdown of the fuel cell system, predicting a second cathode pressure after the shutdown based on the anode pressure and the first cathode pressure, determining, as the opening time of the ACV 122, a time when a difference between the second cathode pressure and the atmospheric pressure is less than a reference pressure corresponding to a maximum emission concentration allowable reference (e.g., 8%) of hydrogen, and opening the ACV 122 at the opening time,

The storage 10 may store various logic, algorithms and programs required in the process of predicting a trend line of the second cathode pressure according to the opening of the ACV 122, determining an opening end time at which a value obtained by integrating the trend line of the second cathode pressure from the opening time of the ACV 122 is less than a reference integral value corresponding to an average emission concentration allowable reference (e.g., average 4% of 3 seconds) of hydrogen, and determining a time from the opening time to the opening end time as the opening maintenance time of the ACV.

The atmospheric pressure sensor 20 may be installed in a fuel cell vehicle to measure atmospheric pressure. The atmospheric pressure sensor 20 may be shut down at the same time as the fuel cell system.

The ACV driver 30 may open and close the ACV 122 under the control of the controller 40. The ACV driver 30 may include one of more of, for example, a motor, a servo, an actuator, etc.

The controller 40 may be electrically connected to each component and may perform overall control such that each component performs its function. The controller 40 may be implemented in the form of hardware or software, or may be implemented in a combination of hardware and software. Preferably, the controller 40 may be implemented as a microprocessor, but is not limited thereto. In the present disclosure, one or more examples are described in which the controller 40 is implemented as a separate configuration, but the function of the controller 40 may be implemented to be performed by the fuel cell control unit (FCU).

The controller 40 may determine the opening time and the opening maintenance time of the ACV 122 in the shutdown state of the fuel cell system, and may open the ACV 122 at the opening time and during the opening maintenance time.

The controller 40 may obtain the anode pressure, the first cathode pressure and the atmospheric pressure before the shutdown of the fuel cell system, predict the second cathode pressure after the shutdown based on the anode pressure and the first cathode pressure, determine the opening time of the ACV 122 based on the second cathode pressure and the atmospheric pressure, and open the ACV 122 at the opening time. In this case, the controller 40 may also predict the first cathode pressure by using the correlation between the anode pressure and the first cathode pressure after the shutdown of the fuel cell system. In addition, the controller 40 may predict the second cathode pressure by using curve fitting.

The controller 40 may predict a trend of the second cathode pressure according to the opening of the ACV 122, and determine the opening maintenance time of the ACV 122 based on the trend of the second cathode pressure.

The controller 40 may obtain the anode pressure, the first cathode pressure and the atmospheric pressure before the shutdown of the fuel cell system, predict the second cathode pressure after the shutdown based on the anode pressure and the first cathode pressure, determine, as the opening time of an ACV 122, a time when the difference between the second cathode pressure and the atmospheric pressure is less than a reference pressure corresponding to the maximum emission concentration allowable reference (e.g., 8%) of hydrogen, and open the ACV 122 at the opening time.

The controller 40 may predict the trend line of the second cathode pressure according to the opening of the ACV 122, determine an opening end time at which a value obtained by integrating the trend line of the second cathode pressure from the opening time of the ACV is less than a reference integral value corresponding to an average emission concentration allowable reference (e.g., average 4% of 3 seconds) of hydrogen, and determine a time from the opening time to the opening end time (e.g., opening end time point) as the opening maintenance time of the ACV. In this case, the result of integrating the trend line of the second cathode pressure from the opening time of the ACV 122 represents an average hydrogen emission amount.

A fuel cell system equipped with the apparatus 100 may be mounted on a vehicle (e.g., a fuel cell vehicle).

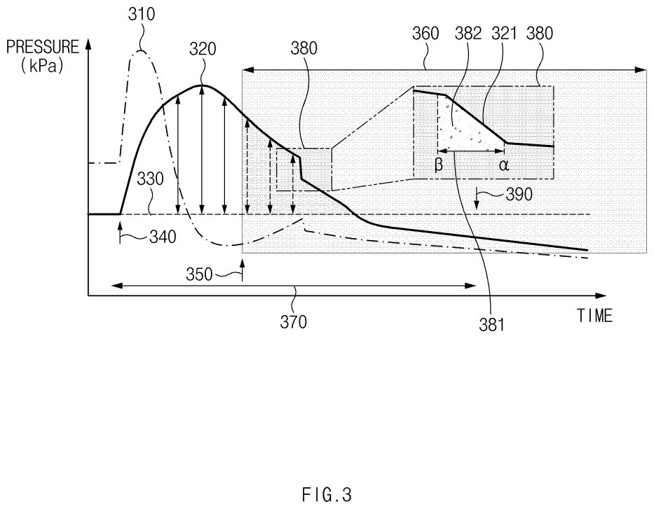

Hereinafter, the operation of the controller 40 will be described in detail with reference to FIG. 3.

FIG. 3 is a diagram illustrating a process in which a controller provided in an apparatus for controlling a valve of an example fuel cell system determines the opening time and the opening maintenance time of an ACV.

In FIG. 3, the vertical axis represents pressure and the horizontal axis represents time. In addition, reference numeral 310 indicates the trend of anode pressure within the stack, reference numeral 320 indicates the trend of cathode pressure within the stack, and reference numeral 330 indicates the trend of atmospheric pressure. In addition, reference numeral 340 indicates the time when the fuel cell system enters shutdown, and reference numeral 350 indicates the time when the fuel cell system completes shutdown. In this case, the shutdown means a state in which the operation (e.g., power generation) of the fuel cell system is stopped.

In addition, reference numeral 360 indicates a section in which the controller 40 cannot monitor the output values of various sensors because various sensors (e.g., FPS 114 and atmospheric pressure sensor 20) do not operate due to the shutdown of the fuel cell system. Reference numeral 370 represents a section in which the controller 40 applies torque to the ACV 122 to maintain the closed state of the ACV 122 before the controller 40 enters a sleep mode after the fuel cell system is shut down. In this case, the controller 40 stops applying torque to the ACV 122 when entering the sleep mode.

In addition, reference numeral 380 indicates a section in which the ACV 122 is opened, reference numeral 321 indicates a trend of cathode pressure within the stack according to the opening of ACV 122, β indicates the opening time of the ACV 122, a indicates the opening end time of ACV 122, and reference numeral 381 indicates the opening maintenance time of the ACV 122.

In this case, the controller 40 may predict the second cathode pressure after a shutdown time (e.g., shutdown time point) 350 by using an anode pressure 310 of the stack and the first cathode pressure before the shutdown time 350. In this case, the controller 40 may use curve fitting, for example.

In addition, the controller 40 may determine, as the opening time of the ACV 122, a time when the difference between the second cathode pressure and the atmospheric pressure is less than the reference pressure corresponding to the maximum emission concentration allowable reference of hydrogen (e.g., 8%). That is, the controller 40 may determine the time that satisfies following Equation 1 as the opening time of the ACV 122.

$${P}_{c a} - {P}_{atm} < {P}_{thr} , \qquad [ Equation l ]$$

where Pca represents the second cathode pressure, Pₐₜₘ represents the atmospheric pressure, and Pₜₕᵣ represents the reference pressure corresponding to the maximum emission concentration allowable reference of hydrogen (e.g., 8%). In this case, the controller 40 may determine the reference pressure Pₜₕᵣ by using the ideal gas equation expressed as following Equation 2.

$${P}_{thr} = \frac{n R T}{V} , \qquad [ Equation 2 ]$$

where V is a fixed value of the volume inside the stack, n is the number of moles of hydrogen, R is the gas constant, and T is the absolute temperature.

That is, the controller 40 may determine the mass m₁ of the discharged hydrogen by multiplying the molar number n of hydrogen by the molar mass of hydrogen (e.g., 2.016 g/mol), determine the mass m₂ of the gas in the air pipe based on the ideal gas equation, and also determine the final hydrogen discharge concentration C based on following Equation 3. In this case, the composition ratio of the air in the air pipe reflects the composition ratio of the air in the atmosphere, and the volume of the air pipe is a fixed value.

$$C = ( \frac{{m}_{1}}{{m}_{1} + {m}_{2}} ) \times 100 \qquad [ Equation 3 ]$$

In addition, the controller 40 may predict the trend line 321 of the second cathode pressure according to the opening of the ACV 122. In this case, the controller 40 may predict the trend line 321 of the second cathode pressure by considering a preset opening amount of the ACV 122.

In addition, the controller 40 may determine the opening end time α at which an integrated value 382 of the trend line 321 of the second cathode pressure from the opening time β of the ACV 122 is less than a reference integral value corresponding to the average emission concentration allowable reference of hydrogen (e.g., average 4% for 3 seconds). That is, the controller 40 may determine the time that satisfies following Equation 4 as the opening end time α of the ACV 122.

$${V}_{i n t} < {V}_{thr} , \qquad [ Equation 4 ]$$

where Vᵢₙₜ represents the value 382 obtained by integrating the trend line 321 (e.g., integrating the area below the trend line 321) of the second cathode pressure from the opening time β of the ACV 122, and Vₜₕᵣ represents a reference integral value corresponding to the average emission concentration allowable reference of hydrogen (e.g., average 4% for 3 seconds).

Reference numeral 390 is the time when the controller 40 enters a sleep mode and the torque applied to the ACV 122 is stopped, and it may be understood that both the anode pressure 310 and the cathode pressure 320 of the stack are lower than the atmospheric pressure 330. Accordingly, even when the torque applied to the ACV 122 is stopped, the ACV 122 may maintain a closed state (e.g., an airtight state of the ACV 122), and thus, the airtight state of the cathode within the stack may be maintained.

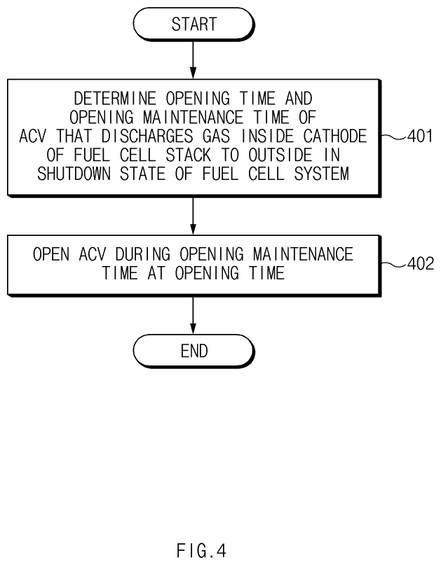

FIG. 4 is a flowchart illustrating an example method of controlling a valve of a fuel cell system.

First, in 401, the controller 40 may determine the opening time and the opening maintenance time of the ACV 122. For example, the controller 40 may determine the opening time and/or the opening maintenance time of the ACV 122 based on one or more internal pressures inside the fuel cell system (e.g., inside a fuel cell stack of the fuel cell system). The ACV 122 may discharge gas inside the cathode of the fuel cell stack to an outside (e.g., through the exhaust of the fuel cell system) when the fuel cell system is in a shutdown state (e.g., after a shutdown of the fuel cell system).

Then, in 402, the controller 40 opens the ACV 122 at the opening time and during the opening maintenance time.

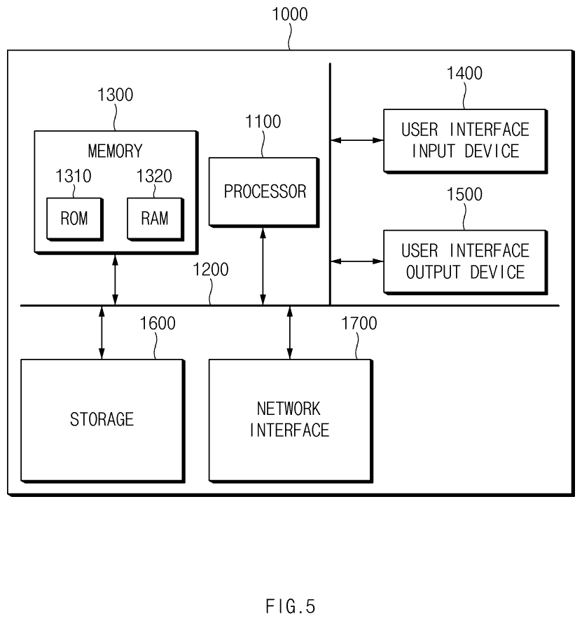

FIG. 5 is a block diagram illustrating an example computing system for executing a method of controlling a valve of a fuel cell system.

Referring to FIG. 5, as described above, the method of controlling a valve of a fuel cell system may be implemented through a computing system 1000. The computing system 1000 may include at least one processor 1100, a memory 1300, a user interface input device 1400, a user interface output device 1500, storage 1600, and a network interface 1700 which are connected through a system bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) 1310 and a random access memory (RAM) 1320.

Accordingly, the processes of the method or algorithm of the present disclosure may be implemented directly by hardware executed by the processor 1100, software (e.g., a software module), or a combination thereof. The software module may reside in a storage medium (that is, the memory 1300 and/or the storage 1600), such as a RAM, a flash memory, a ROM, an EPROM, an EEPROM, a register, a hard disk, a detachable disk, or a CD-ROM. The example storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor and the storage medium may reside in the user terminal as an individual component.

According to the present disclosure, an apparatus for controlling a valve of a fuel cell system includes the valve that discharges gas inside a cathode of a fuel cell stack to an outside, and a processor that determines an opening time point and an opening maintenance time of the valve and opens the valve at the opening time point and during the opening maintenance time when the fuel cell system is in a shutdown state.

The processor may obtain an anode pressure, a first cathode pressure and an atmospheric pressure before a shutdown of the fuel cell system, predict a second cathode pressure after the shutdown based on the anode pressure and the first cathode pressure, and determine the opening time point of the valve based on the second cathode pressure and the atmospheric pressure.

The processor may obtain an anode pressure, a first cathode pressure and an atmospheric pressure before a shutdown of the fuel cell system, predict a second cathode pressure after the shutdown based on the anode pressure and the first cathode pressure, and determine, as the opening time point of the valve, a time point when a difference between the second cathode pressure and the atmospheric pressure is less than a reference pressure.

The processor may determine the reference pressure based on a maximum emission concentration allowable reference of hydrogen.

The processor may predict a trend of the second cathode pressure according to the opening of the valve, and determine the opening maintenance time of the valve based on the trend of the second cathode pressure.

The processor may predict a trend line of the second cathode pressure according to the opening of the valve, determine an opening end time point at which a value obtained by integrating the trend line of the second cathode pressure from the opening time point of the valve is less than a reference integral value, and determine a time from the opening time point to the opening end time point as the opening maintenance time of the valve. The processor may determine the reference integral value based on an average emission concentration allowable reference of hydrogen.

The processor may predict the second cathode pressure based on a curve fitting manner.

According to another aspect of the present disclosure, a method of controlling a valve of a fuel cell system includes determining, by a processor, an opening time point and an opening maintenance time of the valve for discharging gas inside a cathode of a fuel cell stack when the fuel cell system is in a shutdown state, and opening, by the processor, the valve at the opening time point and during the opening maintenance time.

The determining of the opening time point of the valve may include obtaining an anode pressure, a first cathode pressure and an atmospheric pressure before a shutdown of the fuel cell system, predicting a second cathode pressure after the shutdown based on the anode pressure and the first cathode pressure, and determining the opening time point of the valve based on the second cathode pressure and the atmospheric pressure.

The determining of the opening time point of the valve may include obtaining an anode pressure, a first cathode pressure and an atmospheric pressure before a shutdown of the fuel cell system, predicting a second cathode pressure after the shutdown based on the anode pressure and the first cathode pressure, and determining, as the opening time point of the valve, a time point when a difference between the second cathode pressure and the atmospheric pressure is less than a reference pressure.

The determining of the opening time point of the valve may include determining the reference pressure based on a maximum emission concentration allowable reference of hydrogen.

The determining of the opening maintenance time of the valve may include predicting a trend of the second cathode pressure according to the opening of the valve, and determining the opening maintenance time of the valve based on the trend of the second cathode pressure.

The determining of the opening maintenance time of the valve may include predicting a trend line of the second cathode pressure according to the opening of the valve, determining an opening end time point at which a value obtained by integrating the trend line of the second cathode pressure from the opening time point of the valve is less than a reference integral value, and determining a time from the opening time point to the opening end time point as the opening maintenance time of the valve.

The determining of the opening end time point may include determining the reference integral value based on an average emission concentration allowable reference of hydrogen.

The predicting of the second cathode pressure may include predicting the second cathode pressure based on a curve fitting manner.

According to still another aspect of the present disclosure, a vehicle includes a fuel cell stack that produces electrical energy, an air compressor that supplies air to a cathode of the fuel cell stack, and a valve control device that controls air within the fuel cell stack, wherein the valve control device includes a valve that discharges gas inside the cathode of the fuel cell stack to an outside, and a processor that determines an opening time point and an opening maintenance time of the valve and opens the valve at the opening time point and during the opening maintenance time when the fuel cell system is in a shutdown state.

The processor may obtain an anode pressure, a first cathode pressure and an atmospheric pressure before a shutdown of the fuel cell system, predict a second cathode pressure after the shutdown based on the anode pressure and the first cathode pressure, and determine the opening time point of the valve based on the second cathode pressure and the atmospheric pressure.

The processor may predict a trend of the second cathode pressure according to the opening of the valve, and determine the opening maintenance time of the valve based on the trend of the second cathode pressure.

The processor may predict a trend line of the second cathode pressure according to the opening of the valve, determine an opening end time point at which a value obtained by integrating the trend line of the second cathode pressure from the opening time point of the valve is less than a reference integral value, and determine a time from the opening time point to the opening end time point as the opening maintenance time of the valve.

According to one or more example embodiments of the present disclosure, it is possible to control the cathode pressure of a stack to below atmospheric pressure by determining an opening time point and an opening maintenance time of an air cut-off valve (ACV) and opening the ACV at the opening time point and during the opening maintenance time when the fuel cell system is in a shutdown state, such that the closed state of the ACV is maintained even when the closing torque applied to the ACV is stopped.

The above description is a simple exemplification of the technical spirit of the present disclosure, and the present disclosure may be variously corrected and modified by those skilled in the art to which the present disclosure pertains without departing from the essential features of the present disclosure. Therefore, the example embodiment(s) of the present disclosure do not limit the technical spirit of the present disclosure but are illustrative, and the scope of the technical spirit of the present disclosure is not limited by the example embodiment(s) of the present disclosure. The scope of the present disclosure should be construed by the claims, and it will be understood that all the technical spirits within the equivalent range fall within the scope of the present disclosure.

What is claimed is:

1. An apparatus of a fuel cell system, the apparatus comprising:
a valve configured to discharge, through an exhaust of the fuel cell system, gas inside a cathode of a fuel cell stack of the fuel cell system;
a processor; and
a memory storing at least one instruction that is configured, when executed by the processor communicating with the memory, to cause the apparatus to:
determine, based on a pressure measured inside the fuel cell stack, an opening time of the valve and an opening time duration of the valve; and
open, while the fuel cell system is in a shutdown state, the valve at the opening time and keep the valve open for the opening time duration.

2. The apparatus of claim 1, wherein the at least one instruction is configured, when executed by the processor communicating with the memory, to cause the apparatus to determine the opening time by:
obtaining, before a shutdown of the fuel cell system, an anode pressure, a cathode pressure, and an atmospheric pressure;
determining, based on the anode pressure and the cathode pressure, an estimated cathode pressure after the shutdown of the fuel cell system; and
determining, based on the estimated cathode pressure and based on the atmospheric pressure, the opening time of the valve.

3. The apparatus of claim 1, wherein the at least one instruction is configured, when executed by the processor communicating with the memory, to cause the apparatus to determine the opening time by:
obtaining, before a shutdown of the fuel cell system, an anode pressure, a cathode pressure, and an atmospheric pressure; and
determining, based on the anode pressure and the cathode pressure, an estimated cathode pressure after the shutdown of the fuel cell system,
wherein the opening time of the valve is associated with a time when a difference between the estimated cathode pressure and the atmospheric pressure is less than a reference pressure.

4. The apparatus of claim 3, wherein the at least one instruction is configured, when executed by the processor communicating with the memory, to further cause the apparatus to determine the reference pressure based on a reference emission concentration value for hydrogen.

5. The apparatus of claim 2, wherein the at least one instruction is configured, when executed by the processor communicating with the memory, to cause the apparatus to determine the opening time duration by:
determining a projected trend of the estimated cathode pressure after the valve opens; and
determining the opening time duration of the valve based on the projected trend of the estimated cathode pressure.

6. The apparatus of claim 2, wherein the at least one instruction is configured, when executed by the processor communicating with the memory, to cause the apparatus to determine the opening time duration by:
determining a projected trend line of the estimated cathode pressure after the valve opens;
determining a closing time of the valve by determining a time at which an integral, from the opening time, of an area below the projected trend line of the estimated cathode pressure is less than a reference integral value; and
determining the opening time duration based on a time duration between the opening time and the closing time.

7. The apparatus of claim 6, wherein the at least one instruction is configured, when executed by the processor communicating with the memory, to further cause the apparatus to determine the reference integral value based on a reference average emission concentration value for hydrogen.

8. The apparatus of claim 2, wherein the at least one instruction is configured, when executed by the processor communicating with the memory, to further cause the apparatus to determine the estimated cathode pressure by:
determining the estimated cathode pressure using curve fitting.

9. A method performed by a fuel cell system, the method comprising:
determining, by a processor of the fuel cell system and based on a pressure measured inside a fuel cell stack of the fuel cell system, an opening time and an opening time duration of a valve of the fuel cell system; and
opening, while the fuel cell system is in a shutdown state, the valve at the opening time to discharge gas inside a cathode of the fuel cell stack and keeping the valve open for the opening time duration.

10. The method of claim 9, wherein the determining of the opening time of the valve comprises:
obtaining, before a shutdown of the fuel cell system, an anode pressure, a cathode pressure, and an atmospheric pressure;
determining, based on the anode pressure and the cathode pressure, an estimated cathode pressure after the shutdown of the fuel cell system; and
determining, based on the estimated cathode pressure and based on the atmospheric pressure, the opening time of the valve.

11. The method of claim 9, wherein the determining of the opening time of the valve comprises:
obtaining, before a shutdown of the fuel cell system, an anode pressure, a cathode pressure, and an atmospheric pressure; and
determining, based on the anode pressure and the cathode pressure, an estimated cathode pressure after the shutdown of the fuel cell system,
wherein the opening time of the valve is associated with a time when a difference between the estimated cathode pressure and the atmospheric pressure is less than a reference pressure.

12. The method of claim 11, further comprising determining the reference pressure based on a reference emission concentration value for hydrogen.

13. The method of claim 10, wherein the determining of the opening time duration of the valve comprises:
determining a projected trend of the estimated cathode pressure after the valve opens; and
determining the opening time duration of the valve based on the projected trend of the estimated cathode pressure.

14. The method of claim 10, wherein the determining of the opening time duration of the valve comprises:
determining a projected trend line of the estimated cathode pressure after the valve opens;
determining a closing time of the valve by determining a time at which an integral, from the opening time, of an area below the projected trend line of the estimated cathode pressure is less than a reference integral value; and
determining the opening time duration based on a time duration between the opening time and the closing time.

15. The method of claim 14, further comprising determining the reference integral value based on a reference average emission concentration value for hydrogen.

16. The method of claim 10, wherein the determining of the estimated cathode pressure comprises:
determining the estimated cathode pressure using curve fitting.

17. A vehicle comprising:
a fuel cell stack configured to produce electrical energy, wherein the fuel cell stack comprises a cathode and an exhaust;
an air compressor configured to supply air to the cathode of the fuel cell stack;
a valve configured to discharge, through the exhaust, gas inside the cathode; and
a processor circuit configured to:
determine, based on a pressure measured inside the fuel cell stack, an opening time of the valve and an opening time duration of the valve; and
open, while the fuel cell system is in a shutdown state, the valve at the opening time and keep the valve open for the opening time duration.

18. The vehicle of claim 17, wherein the processor circuit is configured to determine the opening time by:
obtaining, before a shutdown of the fuel cell stack, an anode pressure, a cathode pressure, and an atmospheric pressure;
determining, based on the anode pressure and the cathode pressure, an estimated cathode pressure after the shutdown of the fuel cell stack; and
determining, based on the estimated cathode pressure and based on the atmospheric pressure, the opening time of the valve.

19. The vehicle of claim 18, wherein the processor circuit is configured to determine the opening time duration by:
determining a projected trend of the estimated cathode pressure after the valve opens; and
determining the opening time duration of the valve based on the projected trend of the estimated cathode pressure.

20. The vehicle of claim 18, wherein the processor circuit is configured to determine the opening time duration by:
determining a projected trend line of the estimated cathode pressure after the valve opens;
determining a closing time of the valve by determining a time at which an integral, from the opening time, of an area below the projected trend line of the estimated cathode pressure is less than a reference integral value; and
determining the opening time duration based on a time duration between the opening time and the closing time.
